(19) United States
(12) Patent Application Publication
(10) Pub. No.: US 2006/0208534 A1
(43) Pub. Date: Sep. 21, 2006

(54) CONSTRUCTION ELEMENT AND A VEHICLE FRAME COMPRISING SUCH A CONSTRUCTION ELEMENT

(75) Inventors: Hans Regnell, Ytterby (SE); Jens Gustafsson, Goteborg (SE); Benny Liljeblad, Lerum (SE)

Correspondence Address: NOVAK DRUCE & QUIGG, LLP, 1300 EYE STREET NW, 400 EAST TOWER, WASHINGTON, DC, 20005, US

(73) Assignee: VOLVO LASTVAGNAR AB, Goteborg (SE)

(21) Appl. No.: 11/164,380

(22) Filed: Nov. 21, 2005

Related U.S. Application Data
(63) Continuation of application No. PCT/SE04/00428, filed on Feb. 23, 2004.

(30) Foreign Application Priority Data
May 19, 2003 (SE) 0301454-5

(51) Int. Cl. B60R 19/34; B60J 7/00

(52) U.S. Cl. 296/187.09; 293/133

(57) ABSTRACT

An elongate construction element (1; 19, 20) including a first elongate profile (2) with a first section (2′) located in a first plane and a second section (2″) located in a second plane different from the first plane, a second elongate profile (3) with a first section (3′) located in a first plane and a second section (3″) located in a second plane different from the first plane, and at least one third profile (4; 4′, 4″, 4′″, 14). The respective first sections (2′, 3′) of the first and the second profile are located in essentially the same plane, and the third profile (4; 4′, 4″, 4′″, 14) constitutes a web which is fixed to and interconnects the first sections along at least a part of the extent of the construction element. The invention also relates to a frame for a vehicle, which frame comprises at least a pair of such construction elements.

### CROSS-REFERENCE TO RELATED APPLICATIONS

The present application is a continuation patent application of International Application No. PCT/SE2004/000428 filed 23 Mar. 2004 which was published in English pursuant to Article 21(2) of the Patent Cooperation Treaty, and which claims priority to Swedish Application No. 0301454-5 filed 19 May 2003. Said applications are expressly incorporated herein by reference in their entireties.

### TECHNICAL FIELD OF THE INVENTION

The invention relates to elongate construction elements composed of a number of separate parts or profiles, which construction elements can preferably be used for vehicle frames.

### BACKGROUND FO THE INVENTION

Known types of elongate construction element are, for example, beams with I, L and U-shaped cross-sectional profiles. It is characteristic of such beams that they are as a rule manufactured by means of rolling, each section of the parts which form the cross section having the same dimension or thickness along the entire length of the beam. In many applications, a beam does not have to have the same strength, for example flexural rigidity, along its entire length. As the beam has to be dimensioned according to the maximum load to which it will be subjected, it may be overdimensioned along large parts of its length. This is true of, for example, beams included in a vehicle frame.

One problem with overdimensioned beams is that they have a correspondingly great weight. A conventional way of solving this problem has been to cut away parts of the beam for the purpose of saving weight. For beams with I and U-shaped cross-sections, selected parts of the web can be cut away from the parts of the beam which are subjected to relatively low load. However, this method produces a somewhat limited result and moreover is relatively complicated to carry out because it requires very advanced equipment in order to cut out the parts with sufficient precision. Furthermore, a beam dimensioned for the maximum load still has to be used as the starting material, which results in a correspondingly high purchase price. A mistake in the machining of the beam leads in most cases to the whole beam having to be discarded.

One problem the invention aims to solve is to allow the manufacture of beams which are correctly dimensioned along their entire length. Another problem solved by the invention is the use of a lighter and less expensive starting material.

### SUMMARY OF THE INVENTION

In an exemplary embodiment, the invention relates to an elongate construction element comprising a first elongate profile with a first section located in a first plane and a second section located in a second plane different from the first plane and a second elongate profile with a first section located in a first plane and a second section located in a second plane different from the first plane, and at least one third profile.

According to a preferred embodiment, the respective first sections of the first and the second profile are located in essentially the same plane, and the third profile constitutes a web which is fixed to and interconnects the first sections along at least a part of the extent of the construction element. Examples of suitable profiles for this purpose are, for example, T or L profiles. The first sections suitably consist of the upright in a T profile or a leg in an L profile. In the text below, that section of the first and second profiles located in the same plane in order to be interconnected by the third profile is throughout called a “first section”. The third profile, or the web, which connects the first and the second profile is preferably a plate or a plane I profile.

According to one embodiment, the web extends along the entire length of the construction element and has a thickness which is smaller than the thickness of the two first sections. However, the thickness is determined in the first place by calculations which determine the loads to which the construction element may be subjected, which calculations are also dependent on, for example, the number, the positioning and the total extent of all the component webs. The thickness can therefore be constant for all the webs or vary from web to web, depending on the calculations.

According to another embodiment, the web consists of a number of sections positioned at intermittent or regular spacings along the entire length of the construction element. These sections can be positioned on one and the same side of the first sections. The side selected is determined by strength calculations which take account of how the construction element is loaded.

According to another embodiment, the sections of the web can be positioned on different sides of the first sections. Depending on how the construction element is loaded, one or more of the sections of the web can be positioned on opposite sides of the first sections.

According to an alternative embodiment, at least one of the sections of the web can be bent and provided with opposite cutouts corresponding to the thickness of the first sections, the section then being capable of running along both sides of the first sections. A first and a last part of the web therefore run on one side of the first sections, while an intermediate part runs on the opposite side.

In all the embodiments with a web comprising a number of sections, each section can have a length which is the same as or different to that of other sections along the extent of the construction element. As the web, or the central section, on a construction element, or a beam, of the kind indicated above takes up smaller forces when loaded, its dimension can be reduced and/or its longitudinal extent can be reduced to a suitable number of shorter sections. In principle, the central section does not take up any bending forces because these are taken up virtually entirely by the upper and lower sections of the construction element. The central section therefore has to be dimensioned only in order to hold the upper and lower sections in place, and in order to take up vertical load from the upper section, the superstructure of the vehicle (platform and the like) and the load transported by the vehicle.

According to one embodiment, the first and the second profile can have essentially the same cross-sectional profile. For example, two L-profiles can form a U-profile, and two T-profiles can form an I-profile.

According to another embodiment, the first and the second profile can have different cross-sectional profiles. For example, an L-profile and a T-profile can be used.

Irrespective of which profile is used, the first and the second profile can have the same or different dimensions. The web preferably, but not necessarily, has a thickness which is smaller than the thickness of the two first sections it interconnects. Moreover, the distance between a delimiting surface of the web running along a respective first section and the intersection lines of the first and second sections for the first and the second profile respectively can preferably be kept essentially constant.

According to one embodiment, it is possible, for example, for the first profile to be bent so that the distance between the intersection lines of the first and second sections for the first and the second profile respectively converges along at least a part of the extent of the construction element. Along such a tapering part of the construction element, the web, or alternatively its sections, will taper in order to maintain the distance to the respective second profiles.

According to another embodiment, the web is arranged to overlap the first sections. In this connection, the web can be attached to the first sections by means of welding, bolted joints or the like.

According to another embodiment, the outer delimiting edges of the web can be positioned in contact with those edges of the first sections facing these surfaces, the profiles then being welded together.

The invention also relates to a vehicle frame comprising at least two construction elements of the type described above. A conventional frame comprises two beams, which in the present case includes a pair of construction elements consisting of two essentially parallel profiles and at least one third profile interconnecting these profiles.

The third profile preferably consists of a plate which extends along the whole or a limited part of the length of the construction element. Alternatively, the third profile consists of an end plate forming part of a crossbeam which connects the two construction elements. Different combinations of plates and end plates can also be used. In addition to the number of crossbeams and plates, dimensions such as plate thickness and cross section of crossbeams can also be varied freely within the scope of the invention.

### BRIEF DESCRIPTION OF THE DRAWINGS

The invention will be described in greater detail below by means of a number of different illustrative embodiments with reference to accompanying diagrammatic drawing figures, in which:

FIG. 1 shows a composite construction element with an elongate web configured according to a first embodiment of the invention;

FIG. 2A shows a cross section through the construction element according to FIG. 1;

FIG. 2B shows a cross section through an alternative construction element;

FIG. 3 shows a composite construction element with a web consisting of short, intermittently positioned sections;

FIG. 4 shows a composite construction element with a web consisting of short, regularly positioned sections;

FIG. 5 shows a composite construction element with sections of the web positioned on opposite sides of their respective profiles;

FIG. 6 shows a composite construction element with a web comprising bent sections;

FIG. 7 shows a cross section through the construction element according to FIG. 6;

FIG. 8 shows a composite construction element comprising profiles with different cross-sectional profiles;

FIG. 9 shows a composite construction element with a bent profile;

FIG. 10 shows a vehicle frame comprising a number of construction elements according to the invention;

FIG. 11 shows a vehicle frame comprising a number of construction elements according to a first alternative embodiment of the invention; and

FIG. 12 shows a vehicle frame comprising a number of construction elements according to a second alternative embodiment of the invention.

### DETAILED DESCRIPTION

The examples below exemplify a number of simplified beams which are intended only to illustrate the inventive idea. As it is not possible to illustrate all possible variations of dimensions such as height, width, length and cross section, of the profiles included in a construction element, only a limited number of examples are shown.

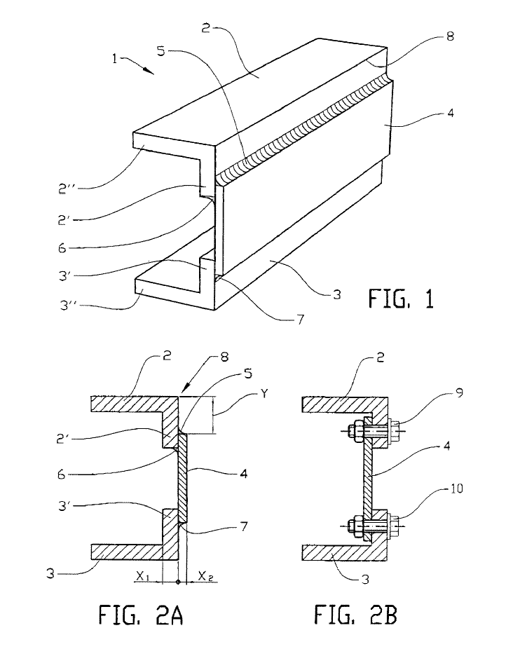

FIG. 1 shows an elongate composite construction element 1 in the form of a beam according to the invention. The beam 1 is constructed from a pair of L-profiles 2, 3 which have first and second sections 2′, 2″; 3′ 3″ respectively. The two first sections 2′, 3′ are positioned in the same plane and run parallel to one another at a constant mutual distance on the longitudinal axis of the beam 1. A third, plane profile 4 forms a web plate, referred to as a web below, which connects the first sections 2′, 3′. FIG. 1 shows an embodiment where the web 4 extends along the entire length of the profile and is fixed to the sections 2′, 3′ by means of welding. The web 4 can be fixed by welds 5, 6 on both sides or alternatively by only one weld 7, depending on the load to which the beam will be subjected. This embodiment allows the composite beam to be provided with a web which is thinner than the web of a standard beam. It is also possible to combine profiles of different cross section, which is described below in connection with FIG. 6.

FIG. 2A shows a cross section through the beam in FIG. 1, where alternative positionings of welded joints 5, 6; 7 can be seen. The figure also shows diagrammatically the thickness ratio between the first sections 2′, 3′ and the web 4. The thickness X2 of the web in relation to the thickness X1 of the first sections is determined by calculations which take account of different loading cases. The distance Y between the upper edge of the web and an intersection line 8 between the first and second sections 2′, 2″ of the first profile 2 is essentially constant.

FIG. 2B illustrates diagrammatically how the web 4 can be mounted on the respective first sections 2′ and 3′ of the first and second profiles 2, 3 by means of a number of bolted joints 9, 10. FIGS. 2A and 2B also show that the web 4 can be positioned on different sides of the two first sections. The positioning of the web relative to the first sections does not have to be symmetrical as shown in FIGS. 2A-B, but can also be asymmetrical and be varied with respect to the cross-sectional shape of the first and second profiles.

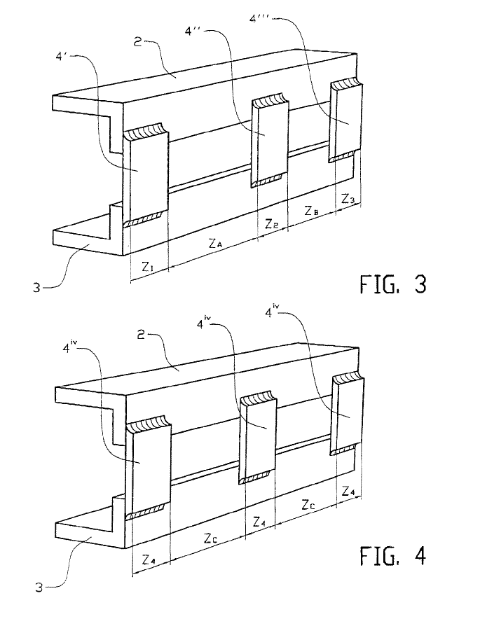

FIG. 3 shows an embodiment of the invention where the beam comprises a first and a second profile 2, 3 connected to a web and consisting of a number of sections 4′, 4″, 4′″. These sections have the same height but different widths Z1, Z2, Z3 and are positioned at different mutual spacings ZA, ZB. The number, positioning and width of the sections which constitute the web are dependent on the load to which the beam will be subjected.

FIG. 4 shows an alternative embodiment of the beam according to FIG. 3. This beam has a web in the form of a number of similar sections 4iv, which have the same width Z4 and are positioned at the same mutual spacing ZC.

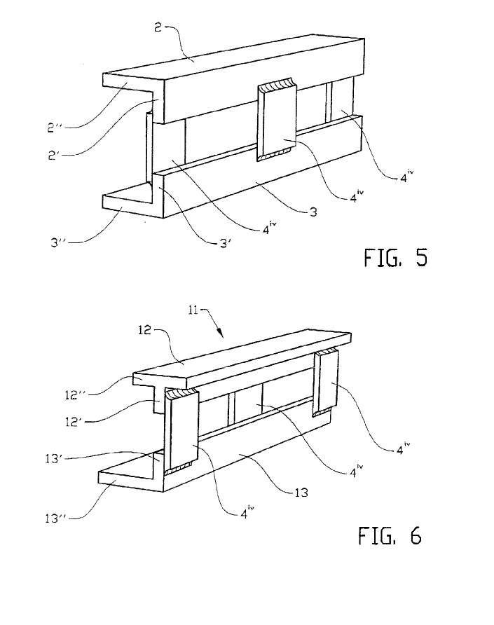

FIG. 5 shows an alternative embodiment of the beam according to FIG. 4. This beam is provided with a web in the form of a number of sections 4iv, which are positioned on both sides of the first sections 2′, 3′ of the two profiles 2, 3. As described above, the thickness, width and relative positioning of the sections 4iv of the web can be selected on the basis of calculations performed for the expected load on the beam.

FIG. 6 shows an embodiment of the invention where the beam comprises a first and a second profile 12, 13 connected to a web consisting of a number of sections 4iv. In this case, the first profile 12 has a T-shaped cross section, and the second profile 13 has an L-shaped cross section. The two profiles comprise a first and a second section 12′, 13′; 12″, 13″ respectively, which are connected to a web consisting of a number of sections 4iv. This figure illustrates that it is possible to use profiles of different cross section in the construction element.

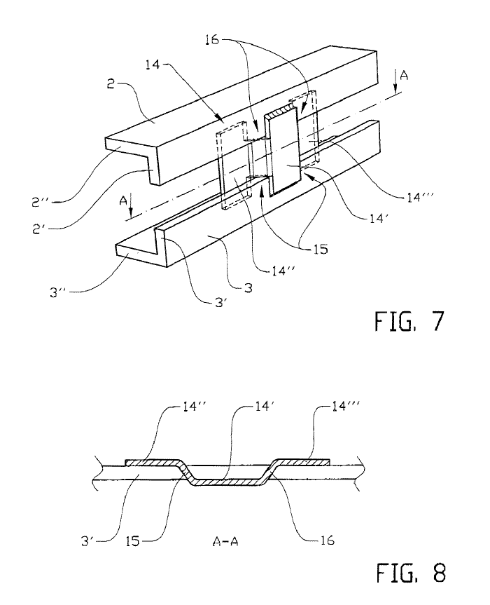

FIG. 7 shows an embodiment where the first and second profiles 2, 3 of the beam are connected to a web in the form of a bent section 14. The bent section 14 is provided with cutouts 15, 16 which are intended to interact with the first sections 2′, 3′ of the two profiles 2, 3. The width of the cutouts 15, 16 is proportional to the thickness of the first section 2′, 3′ with which they are intended to interact. In addition, the web is bent so that a central part 14′ bears against one side of each first profile 2, 3 and a pair of side parts 14″, 14″ on each side of the central part bear against the opposite side of each first profile 2, 3 when the web is mounted between the profiles. In this connection, the web 14 is bent in the region between the opposite cutouts 15, 16 arranged in pairs. FIG. 8 shows a section through the web 14 in the longitudinal direction of the beam, where it can be seen clearly how the web 14 interacts with the second profile 3.

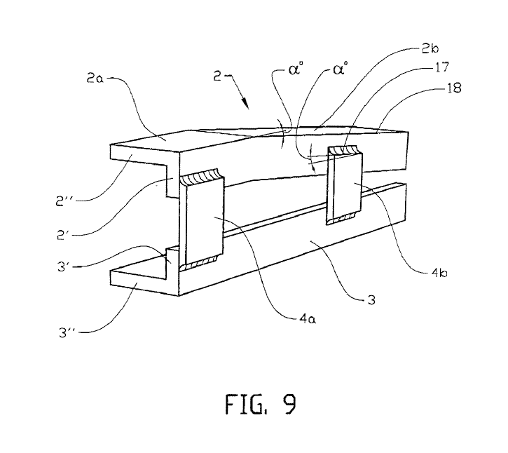

FIG. 9 shows an embodiment of the invention where the beam comprises a first and a second profile 2, 3, where the first profile has been bent at one end. A first part 2a of the first profile 2 is parallel to the second profile, while a second part 2b converges with the second profile. The profiles 2, 3 are interconnected by a web consisting of a number of sections 4a, 4b. In this regard, the first section 4a is fixed in the way indicated above, described in connection with FIGS. 3-5 above. The second section 4b has an upper delimiting surface 17 which is angled relative to the corresponding lower delimiting surface. This angle a corresponds to the inclination a of the second part 2b of the bent profile 2 relative to its first part 2a. The upper delimiting surface 17 of the second section 4b thus maintains a constant distance to the intersection line 18 between the first and second sections 2′, 2″ of the first profile 2.

The figures which illustrate the embodiments above are only diagrammatic and show simplified parts of a number of beams according to the invention. The thickness, width and relative positioning of the sections of the web can therefore be selected on the basis of calculations performed for the expected load on the beam. As far as distances between the sections which constitute the web are concerned, it is possible to vary these over and above the examples shown in FIGS. 3-6. It is possible, for example, to have sections on opposite sides of the first and second profiles overlap one another wholly or partly. In this connection, the number, spacing and any overlap of the sections of the web are determined by the strength calculations mentioned above. The examples above show the simplest possible way of joining the profiles together. As indicated in connection with FIGS. 1, 2A and 2B, both the positioning and the number of welded joints, bolted joints or the like can be varied freely without departing from the inventive idea.

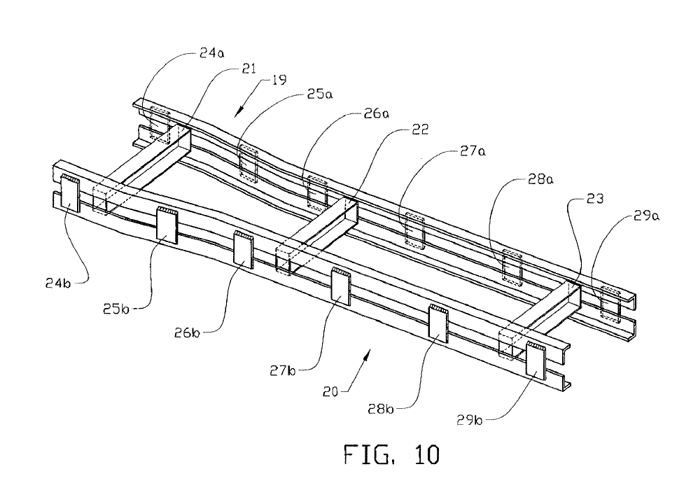

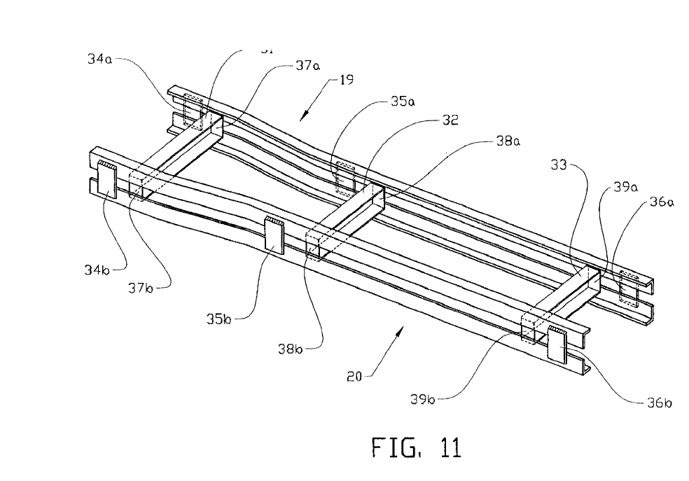

FIG. 10 shows a vehicle frame comprising a number of construction elements according to the invention. The frame comprises first and second composite elongate beams 19, 20, each consisting of a pair of L-profiles. In this case, the profiles are joined together according to the embodiments described in connection with FIGS. 3 and 4. The frame also comprises three crossbeams 21, 22, 23 which hold the elongate beams 19, 20 together. The crossbeams can be mounted by bolted joints or welded firmly to either or both of the profiles which constitute an elongate beam. Each such beam 19, 20 comprises two profiles joined together by means of a number of webs 24a, 25a, 26a, 27a, 28a, 29a and 24b, 25b, 26b, 27b, 28b, 29b respectively, in this case six web plates on each side.

The number and positioning of webs, and where appropriate, crossbeams, can be varied freely within the scope of the invention, depending on factors such as size, area of application and load for the vehicle for which the frame is intended.

FIG. 11 shows a vehicle frame comprising a number of construction elements according to a first alternative embodiment of the invention. The frame comprises first and second composite elongate beams 19, 20, as described in connection with FIG. 10. In this case too, the frame comprises three crossbeams 31, 32, 33 which hold the elongate beams 19, 20 together. The crossbeams are preferably, but not necessarily, mounted by means of welding to both profiles. According to this embodiment, the two profiles of the beams are joined together by means of a reduced number of webs 34a, 35a, 36a and 34b, 35b, 36b respectively, in this case three web plates on each side. The end plates 37a, 38a, 39a and 37b, 38b, 39b respectively which terminate the usually U-shaped cross section of the crossbeams 31, 32, 33 thus replace a corresponding number of webs, compared with the embodiment according to FIG. 10.

The number and positioning of crossbeams and webs can be varied freely within the scope of the invention, depending on factors such as size, area of application and load for the vehicle for which the frame is intended.

FIGS. 10 and 11 show only embodiments where webs and crossbeams are throughout located at different positions along the length of the vehicle frames. It is of course possible for the positioning of one or more webs to coincide with the end surfaces of one or more crossbeams.

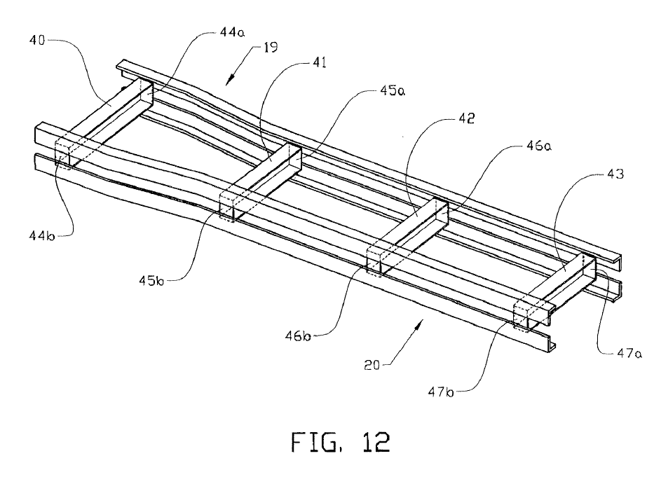

FIG. 12 shows a vehicle frame comprising a number of construction elements according to a second alternative embodiment of the invention. The frame comprises first and second composite elongate beams 19, 20, as described in connection with FIG. 11. According to this embodiment, the two profiles of the beams are joined together by means of only the end plates 44a, 45a, 46a, 47a and 44b, 45b, 46b, 47b respectively which terminate the usually U-shaped cross section of the crossbeams 40, 41, 42, 43. According to this embodiment, all webs are replaced by the end plates which terminate the U-shaped cross section of the crossbeams. It is true that the increased number of crossbeams leads to an increase in weight, but it is possible to compensate for this by reducing the dimensions or cross-sectional area of the crossbeams.

In this case too, the number and relative positioning of the crossbeams can be varied freely within the scope of the invention, depending on factors such as size, load and area of application for the vehicle of which the frame is to form part.

The invention is not limited to the illustrative embodiments described above and shown in the drawings but can be varied within the scope of the patent claims.

What is claimed is:

1. An elongate construction element (1; 19, 20) comprising a first elongate profile (2) with a first section (2′) located in a first plane and a second section (2″) located in a second plane different from the first plane, a second elongate profile (3) with a first section (3′) located in a first plane and a second section (3″) located in a second plane different from the first plane, and at least one third profile (4; 4′, 4″, 4′″, 14), wherein the respective first sections (2′, 3′) of the first and the second profile are located in essentially the same plane and the third profile (4; 4′, 4″, 4′″, 14) constitutes a web which is fixed to and interconnects said first sections along at least a part of the extent of the construction element.

2. The construction element as recited in claim 1, wherein said web (4) extends along the entire length of the construction element (1).

3. The construction element as recited in claim 1, wherein said web consists of a number of sections (4′, 4″, 4′″) positioned at intermittent spacings along the entire length of the construction element.

4. The construction element as recited in claim 1, wherein said web consists of a number of sections (4iv) positioned at regular spacings along the entire length of the construction element.

5. The construction element as recited in claim 3, wherein the sections (4′, 4″, 4′″) of the web are positioned on one and the same side of the first sections (2′, 3′).

6. The construction element as recited in claim 4, wherein the sections (4iv) of the web are positioned on different sides of the first sections (2′ 3′).

7. The construction element as recited in claim 3, wherein at least one of the sections (14) of the web is bent and provided with opposite cutouts (15, 16) corresponding to the thickness of the first sections (2′, 3′), the section then being capable of running along both sides of the first sections.

8. The construction element as recited in claim 1, wherein the first and the second profile (12, 13) have essentially the same cross-sectional profile.

9. The construction element as recited in claim 1, wherein the first and the second profile (12, 13) have different cross-sectional profiles.

10. The construction element as recited in claim 8, wherein the first and the second profile have different dimensions.

11. The construction element as recited in claim 8, wherein the distance between a delimiting surface of the web running along a respective first section and the intersection lines of the first and second sections for the respective profile are essentially constant.

12. The construction element as recited in claim 8, wherein the first profile (2) is bent so that the distance between the intersection lines of the first and second sections (2′, 2″; 3′, 3″) for the respective profile (2, 3) converges along at least a part (2b) of the extent of the construction element.

13. The construction element as recited in claim 8, wherein the third profile consists of a plate (4; 14; 34a, 34b, 35a, 35b, 36a, 36b) which connects the two construction elements.

14. The construction element as recited in claim 8, wherein the third profile consists of an end plate (37a, 37b, 38a, 38b, 39a, 39b) forming part of a crossbeam which connects the two construction elements.

15. The construction element as recited in claim 1, wherein the web is arranged to overlap the first sections.

16. A vehicle frame including at least two construction elements, each comprising two essentially parallel profiles with at least one interconnecting third profile (4; 14; 34a, 34b, 35a, 35b, 36a, 36b; 37a, 37b, 38a, 38b, 39a, 39b) therebetween, each of said construction elements comprising a first elongate profile (2) with a first section (2′) located in a first plane and a second section (2″) located in a second plane different from the first plane, a second elongate profile (3) with a first section (3′) located in a first plane and a second section (3″) located in a second plane different from the first plane, and at least one third profile (4; 4′, 4″, 4′″, 14), wherein the respective first sections (2′, 3′) of the first and the second profile are located in essentially the same plane and the third profile (4; 4′, 4″, 4′″, 14) constitutes a web which is fixed to and interconnects said first sections along at least a part of the extent of the construction element.

17. The vehicle frame as recited in claim 16, wherein said third profile consists of a plate (34a, 34b, 35a, 35b, 36a, 36b) which extends along a limited part of the length of the construction element (19, 20).

18. The vehicle frame as recited in claim 16, wherein said third profile consists of an end plate (37a, 37b, 38a, 38b, 39a, 39b) forming part of a crossbeam (31, 32, 33) which connects the two construction elements (19, 20).
